(19) United States
(12) Patent Application Publication
(10) Pub. No.: US 2017/0132370 A1
(43) Pub. Date: May 11, 2017

(54) Method of Registering a Donor and Collecting Donor Data

(71) Applicant: Jay Feinberg, Boca Raton, FL (US)

(72) Inventor: Jay Feinberg, Boca Raton, FL (US)

(21) Appl. No.: 15/293,852

(22) Filed: Oct. 14, 2016

Related U.S. Application Data
(60) Provisional application No. 62/241,302, filed on Oct. 14, 2015.

(51) Int. Cl. G06F 19/00

(52) U.S. Cl. CPC G06F 19/322

(57) ABSTRACT

A method of obtaining a commitment from a prospective donor for using the donor's bone marrow by providing the donor a registration kit, then providing instructions to the donor to record donor data in the registration kit, then providing instructions for the donor to obtain DNA samples on cotton swabs and secure the cotton swabs in the registration kit, then entering the donor's data into a computer system, then communicating with the donor to commit to donating the donor's bone marrow, then obtaining a commitment from the donor to donate the donor's bone marrow prior to testing of the donor's DNA and then testing the donor's DNA for eligibility as a bone marrow donor.

### CROSS REFERENCE TO RELATED APPLICATIONS

This application claims benefit of U.S. Provisional Patent Application No. 62/241,302 filed Oct. 14, 2015, entitled Method of Obtaining Written Consent from a Donor Using a Flyer, the disclosure of which is incorporated herein by reference in its entirety.

### BACKGROUND OF THE INVENTION

a) Field of the Invention:

The present invention is method for use by organizations that collect data about potential donors, store the potential donor data in the organization's data bases or registry, until the data is needed at a subsequent time.

The organization continuously seeks new potential donors, often at organized events or donor drives where volunteers seek out potential donors. Potential donor data is obtained through a minimally invasive process, by taking a swab from the inside of the cheek of the potential donor. This test information is stored by the organization with donor data in its data bases. Though potential donors typically are willing to agree to provide donor data and agree to a testing process of having their cheek swabbed, this can be a time consuming process and expensive as well. The present invention reduces the time to sign up a potential donor and reduces the expenses associated with the testing process by testing of qualified donors.

The conventional method of registering potential donors for bone marrow and blood stem cell transplants takes approximately seven to ten minutes, typically at donor recruitment drives. This method usually includes the following steps:

A registry volunteer hands a potential donor a brochure to read which explains the donation process.

The potential donor is required to complete a two-sided consent form that requests contact information, information regarding date of birth, height, weight, gender, and race and ethnicity; requires the completion of a health history questionnaire; and includes a consent section for signature by the potential donor.

The potential donor is also given a handout that lists health factors that may disqualify him/her from becoming a donor.

Once the potential donor has completed the consent form, the registry volunteer shows the donor how to swab the inside of the donor's cheeks.

In the swabbing process, the potential donor takes two samples from the upper cheek quadrants, and two samples from the lower cheek quadrants with four swabs provided by the registry volunteer.

On a separate sheet, the registry volunteer is provided with four bar code labels which he/she attaches to each of the four discrete components associated with the registration process. The registry volunteer affixes an individual bar code label to the:

four swabs from the potential donor after placing them in foam slits located in the swab kit;

potential donor consent/health history form;

outside of the envelope in which the swab collection kit is enclosed;

donor membership identification card which is given to the potential donor.

### SUMMARY OF THE INVENTION

The present method reduces the amount of time to register a potential donor. The method includes the following steps:

The same educational materials as those provided in the conventional method are given to potential donors in the present method, including the informational brochure and the sheet listing health conditions that may disqualify a potential donor.

The two-page consent/health history form used in the conventional method is not used in the present method. Rather, the potential donor only needs to complete a brief request for information which is located on the inside of the envelope that will contain the swab collection kit, and the donor provides a signature below the requested information which authorizes the cheek swabbing.

A section inside the swab kit envelope also advises the donor that completing the swab kit is only half of the registration process, and that the donor will receive an email from the registry requesting completion online of the other half of the registration process. The donor is further advised that the swab sample will not be processed until the donor completes the registration.

The registry volunteer then shows the potential donor how to swab the inside of the donor's cheeks.

As in the conventional swabbing process, the potential donor takes two samples from the upper cheek quadrants, and two samples from the lower cheek quadrants with four swabs provided by the registry volunteer.

Bar code labels for the registration and swabbing procedures are attached to the inside of the swab kit envelope, with instructions to the volunteer as to where and how to affix them. Three “Donor ID Barcode Labels” for placement inside the collection kit and outside the envelope, and four “‘Flag’ Bar Code Labels” to wrap around each of the four donor swabs are provided. The locations of the placement of the Donor ID bar code labels are clearly indicated by three yellow rectangles: (a) two are in the inside of the swab kit envelope, numbered 1 and 2; and (b) the third yellow rectangle, displaying the number 3 and a sample bar code label, is depicted across a drawing of the four collection swabs inside the collection kit, indicating swab placement, with instructions to affix an actual yellow rectangular strip in the kit with a donor identification bar code label attached to it across all four swabs.

As indicated in Section F above, the registry volunteer affixes a designated “flag” bar code label around each of the four individual swabs from a potential donor, then places the swabs into foam slits in the kit, and lastly places a yellow adhesive strip across the swabs to hold them in place and affixes a Donor ID bar code label across the yellow strip.

After a donor recruitment drive, the registry sends a follow-up email to each potential donor, providing a link to a secure site so that the donor may fill out a consent form and a health history questionnaire in order to complete the registration process.

Advantages of the present registration method over the prior conventional methods of registration include the following:

The two-page consent form and health history questionnaire in the conventional registration method takes time to complete at a donor recruitment event.

There is a lack of privacy for the potential donor in the conventional registration method in that the potential donor has to provide confidential medical information on the consent/health history form in a public place where others may see the information.

In the conventional registration method, potential donors do not have as much time to educate themselves about the donation process as the potential donors in the present registration method.

Commitment to donate and donor retention will be much lower in the conventional method than in the present method because of lack of time for potential donors to educate themselves about the donation process.

The bar code labeling in the conventional method of registering potential donors may lead to potential errors because the bar code labels are provided on a sheet that is separate from the kit for each component involved in the registration and swabbing process. When registry employees later receive the consent/health history forms and enter the information therein into the registry computer system, errors could be made because forms and swabbing kits may have been mislabeled with bar codes that do not correlate with each other. The present method of affixing a designated flag bar code label around each individual swab instead of the conventional method of placing only one label across all four swabs decreases the possibility of any error.

In the present method, data entry does not take as much time as that in the conventional process because registry employees only need to enter the abbreviated information provided by a potential donor inside the swab collection kit envelope, rather than two pages of potential donor information in the long form in the conventional method.

The conventional registration method has the potential to waste time, materials and money, especially in regard to the cost of testing the swabs to determine matches between potential donors and patients requiring bone marrow or blood stem cell transplants. In the conventional method, the swabs are tested automatically after the registration process is concluded at a donor recruitment drive. The cost for each test of swabs from a potential donor could be as much as $60. In the present method, laboratory testing takes place only after the potential donor responds to a follow-up email from the registry that requests completion of a consent form and health history questionnaire in order to complete the registration process. Potential donors registered through the present registration method are likely to be more committed and responsive than those registered through the conventional method, and are more likely to proceed with a bone marrow or blood stem cell donation when called upon as a match, even if many years have elapsed since registration. Thus, money is not wasted as much on unnecessary laboratory testing.

### BRIEF DESCRIPTION OF THE DRAWINGS

FIG. 1 is a plan view of the outer envelope of the present invention with both outer sides shown, the outer side of the front flap and the outer side of the pocket of the outer envelope.

FIG. 2 is a plan view of the inner sides of the outer envelope of the present invention with both inner sides shown, the inner side of the front flap and the inner side of the pocket of the outer envelope.

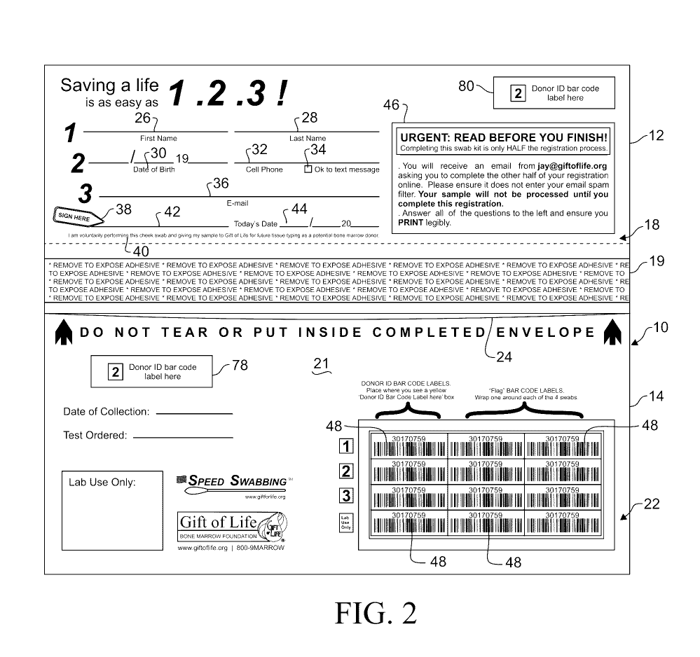

FIG. 3 is a plan view of the outer envelope showing an inner envelope protruding from a pocket within the outer envelope.

FIG. 4 is a plan view of inner sides of the outer envelope and the inner envelope, in a closed position, removed from the pocket of the outer envelope.

FIG. 5 is a plan view of the inner sides of the inner envelope along with the contents of the inner envelope including two packages of sterile cotton tipped applicators and an adhesive label with a liner.

FIG. 6 is a plan view of the inner sides of the inner envelope.

### DESCRIPTION OF THE PREFERRED EMBODIMENTS

The present invention is a method of registering a donor using a method and apparatus to speedily collect data about the donor while increasing the retention rate of prospective donors of bone marrow. As stated above, donors typically sign up to donate at a donor drive where many prospective donors are urged to register. The present invention speeds up this registration process and increases the success rate of retaining donors.

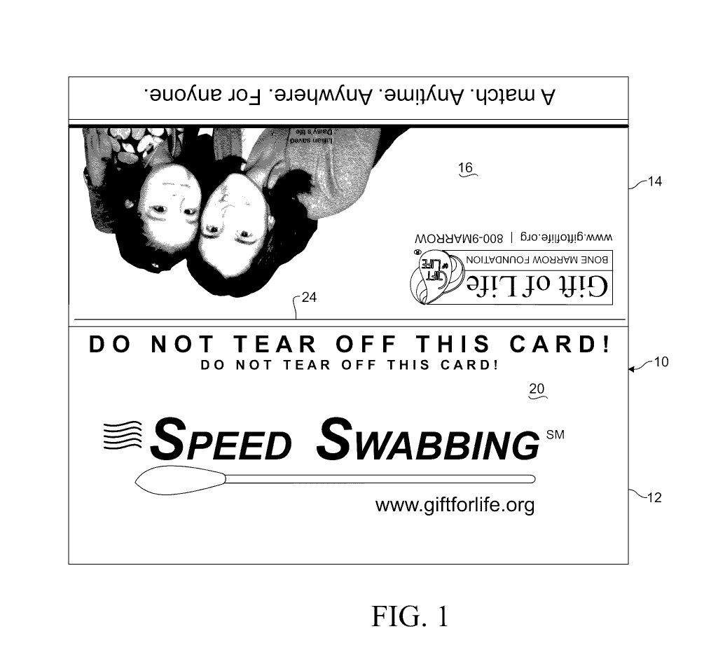

As seen in FIG. 1 a first or outer envelope 10 is provided to prospective donors at a sign up table at the donor drive where a volunteer will provide the first envelope 10 to the prospective donor. The volunteer will have the prospective donor open the first envelope 10 and the prospective donor will see instructions on the two inside sides of envelope 10.

First envelope 10 has a front flap 12 and a pocket portion 14. Front flap 12 has an outer side 16 and an inner side 18. Pocket portion 14 has an outer side 20 and an inner side 22. The front flap 12 and pocket portion 14 are separated by a fold line 24.

Inner side 18 has an adhesive strip 19 with a protective liner 21 to be used to seal envelope 10 after use when a prospective donor provides the donor's data information at the donor drive.

Initially the donor with or without the guidance of the volunteer will follow the written and visual instructions on the inner side of the front flap 18 to obtain swab information about the donor. At line 1, by writing (not shown in the figures, as entered therein) the donor's first and last name at the first name portion 26 and at the last name portion 28. At line 2 by writing the date of birth information at the date of birth portion 30 and cell phone information at the cell phone portion 32 and by checking or not checking the box accepting “OK to text message” at the OK to text message portion 34. At line 3 by entering the donor's email in the email portion 36.

Below line 3 at the “SIGN HERE” icon 38, the donor will have read the bottom printed agreement line 40 “I am voluntarily performing this cheek swab and giving my sample to Gift of Life for future tissue typing as a potential bone marrow donor.” Then the donor will sign where indicated on the signature line 42 and enter the date at the “Today's Date” portion of the line 44.

Prior to signing and finishing the supplying of donor data and providing donor swabbing, the prospective donor will have also read the “urgent” box 46 which contains the following language: “URGENT”: READ BEFORE YOU FINISH! Completing this swab kit is only HALF the registration process. “You will receive an email from an organizer asking you to complete the other half of your registration online. Please ensure it does not enter your email spam filter. Your sample will not be processed until you complete this registration.”

“Answer all of the questions to the left and ensure you PRINT legibly.”

At the inner side 22 of pocket portion 14, is a matrix of bar code identification labels 48. There are twelve of the bar code labels 48 attached to the inner side 22 of pocket portion 14. Labels 48 are attached with an adhesive and are each easily individually peeled off the inner side 22. Each label 48 has unique donor ID code. This ID code identifies the donor associated with the donor kit 50. This ID code minimizes potential for any errors in handling of the Donor's information and donor's swab specimens.

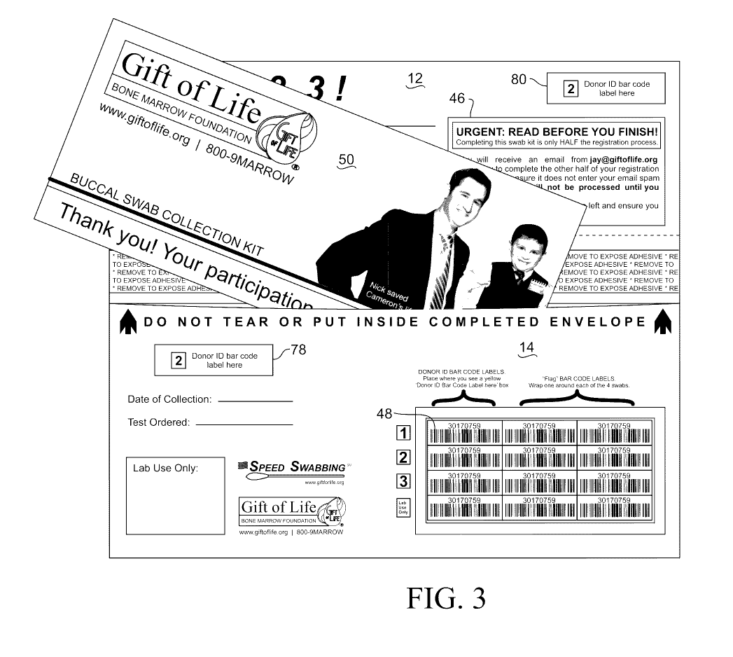

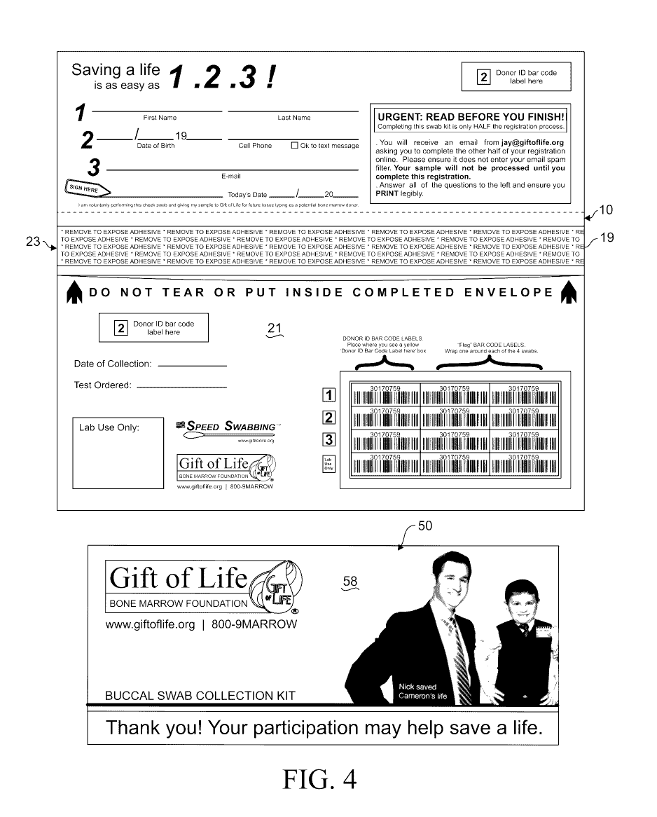

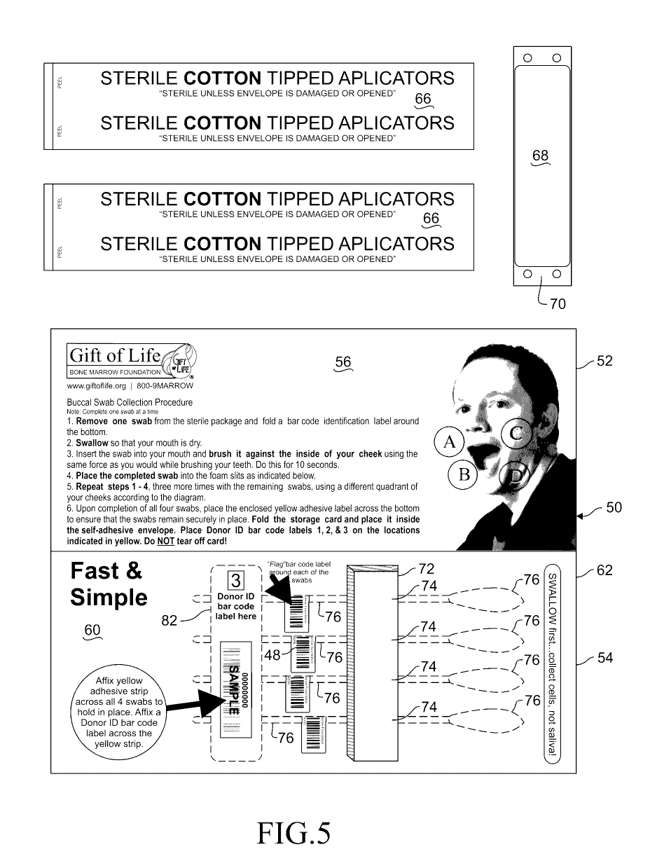

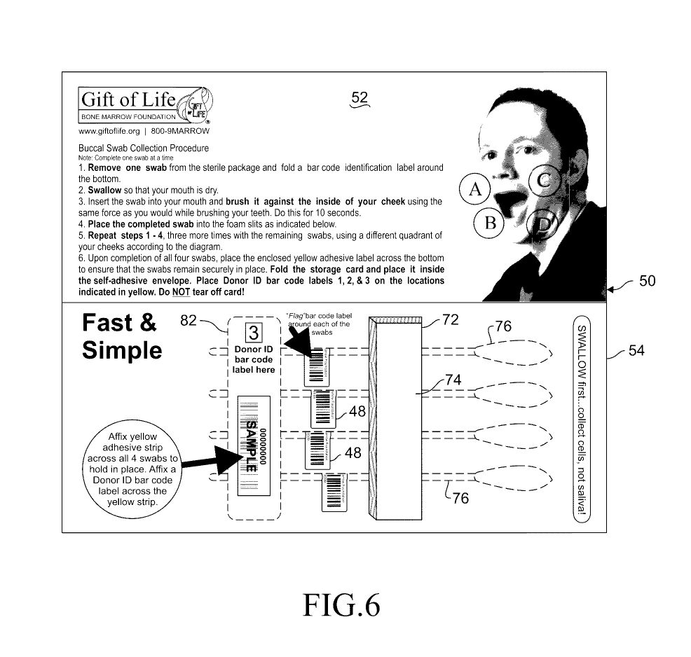

After the prospective donor has signed on the signature line 42 and completed the rest of the information, the prospective donor will be shown by the volunteer how to perform a swab collection from the inside of the donor's cheeks. To do this, referring to FIGS. 3, 4, 5 and 6, a second or inner envelope 50, also called the donor kit 50 will be removed from inside of the pocket portion 14 of the outer envelope 10.

Donor kit 50 is a folded flap having a top flap 52 and a bottom flap 54. Top flap 52 having an inner portion 56 and an outer portion 58. Bottom flap 54 having an inner portion 60 and an outer portion 62 not shown.

Donor kit 50 has there within four sterile cotton tipped applicators 64 in two sealed packages 66. Also included is an adhesive label 68 with a removable liner 70.

The bottom flap 54 of donor kit 50 is constructed and arranged to receive the four cotton tipped applicators or swabs 64 to be held in a foam strip 72 attached to the bottom flap 54.

The swabbing instructions are also shown on the inner portion 56 of the top flap 52 of the donor kit 50, so that the donor can review them if necessary during the swabbing procedure. The buccal swab is referenced on the inner portion of the top flap 52 of the donor kit 50. The buccal swab, also known as buccal smear, is a well-known procedure to collect DNA from the cells on the inside of a person's cheek, a relatively non-invasive way to collect DNA samples for testing. Buccal translates as cheek or mouth.

The instructions guide the donor to remove one swab 64 from the sealed package 66 and to fold a bar code identification label 48 around the bottom of the swab 64. Then after swabbing with the swab 64, the swab 64 is placed in a foam slit 74. The inner portion 60 of bottom flap 54 has a diagram of four swabs 76 to help the donor place the actual swabs 64 in the correct position and placement in the donor kit 50. The process of swabbing is repeated four times until all four swabs 64 have been placed in the foam slits 74. Then the label 68 is place across all four swabs 64 to hold the swabs 64 in place on the inner portion 60 of bottom flap 54. Additionally a donor ID 48 is placed across the label 68, and wherever there is a notation or icon requesting the Donor attach a label 68, including at the box 78 on the inner side 22 of pocket 14 with the number 1 in a box followed by the words “Donor ID bar code label here” and at the box 80 on the inner side 18 of front flap 12 with the number 2 in a box followed by the words “Donor ID bar code label here” and as previously stated at the box 82 on the label 68 on the inner portion 60 of donor kit 50 with the number 3 in a box followed by the words “Donor ID bar code label here” that is imprinted on the inner portion 54.

The volunteer at the drive collects all the sealed envelopes 10 containing the donor kits 50 having the cotton swabs 64 for each of the prospective donors. Each of the sealed envelopes 10, donor kits 50, cotton swabs 64 are safely identified with the prospective donor's ID bar code label 48 to identify the potential donor. Additionally the donor information contained on the inner side 18 of front flap 12 contains the donor information and includes thereon a donor ID bar code 48.

Upon completion of swabbing all four swabs 64 are placed in the foam slits 74. The donor secures the swabs 64 with the label 68 and the donor kit 50 also known as the storage card 50 is placed within the pocket portion 14 of the outer envelope 10. The envelope 10 is then sealed shut by removal of the liner 21 to expose the adhesive 19 to seal the flap 23 to close the reusable first envelope 10 so that it can be collected by the volunteer at the donor drive.

This donor information on the inner side 18 of front flap 12 is then scanned by a recognition system into a computer database. Later, when the prospective donor is sent a communication to the email address entered at line 36, the donor will indicate a willingness to become a donor subject to the testing of the donor's DNA on the swabs 64. At this time the swabs 64 will be sent to a lab for analysis to determine based on the donor's DNA samples if the donor meets the requirements to be a bone marrow donor. It is noted herein that the analysis of the donor's DNA is not performed until the donor confirms willingness to be a donor by providing additional information online to the volunteer's organization. This avoids unnecessary testing and laboratory expenses of testing all prospective donors.

In summary, the present invention is a method of obtaining a commitment from a prospective donor for using the donor's bone marrow by providing the donor a registration kit, then providing instructions to the donor to record donor data in the registration kit, then providing instructions for the donor to obtain DNA samples on cotton swabs and secure the cotton swabs in the registration kit, then entering the donor's data into a computer system, then communicating with the donor to commit to donating the donor's bone marrow, then obtaining a commitment from the donor to donate the donor's bone marrow prior to testing of the donor's DNA, and then testing the donor's DNA for eligibility as a bone marrow donor.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A method for a donor bank to obtain a commitment from a prospective donor for using a donor's bone marrow comprising the steps of:
providing the donor a registration kit;
providing instructions to the donor to record donor data in the registration kit;
providing instructions to the donor for the donor to obtain DNA samples on cotton swabs and how to secure the cotton swabs in the registration kit;
the donor bank entering the donor data into a computer system;
communicating with the donor to obtain the commitment for donating the donor's bone marrow;
obtaining the commitment from the donor to donate the donor's bone marrow prior to testing of a donor's DNA; and
testing the donor's DNA for eligibility as a bone marrow donor.

2. The method according to claim 1, further comprising placing the donor's DNA testing results in a database of donors.
